(19) United States
(12) Patent Application Publication
(10) Pub. No.: US 2025/0101276 A1
(43) Pub. Date: Mar. 27, 2025

(54) PRESSURE-SENSITIVE ADHESIVE

(71) Applicant: LG CHEM, LTD., Seoul (KR)

(72) Inventors: Jin Ho SON, Daejeon (KR); Hui Je LEE, Daejeon (KR)

(73) Assignee: LG CHEM, LTD., Seoul (KR)

(21) Appl. No.: 18/715,547

(22) PCT Filed: May 26, 2023
(86) PCT No.: PCT/KR2023/007308

§ 371 Date: May 31, 2024

(30) Foreign Application Priority Data
May 27, 2022 (KR) 10-2022-0065231

(51) Int. Cl. C09J 133/06; C09J 7/38

(52) U.S. Cl. CPC C09J 133/066; C09J 7/385; C09J 2301/302; C09J 2301/312; C09J 2433/00; C09J 2467/005

(57) ABSTRACT

The present application may provide a pressure-sensitive adhesive, which is applied to a flexible device, thereby effectively responding to repeated deformation and recovery, causing no defects (for example, observation of deformation traces and the like) before and after deformation, having excellent cuttability and workability, and causing no lifting, delamination, and/or bubble generation, and a use thereof.

### TECHNICAL FIELD

This application is a 35 U.S.C. § 371 National Phase Entry Application from PCT/KR2023/007308, filed on May 26, 2023, which claims the benefit of priority based on Korean Patent Application No. 10-2022-0065231 filed on May 27, 2022, the disclosures of which are incorporated herein by reference in their entireties.

The present application relates to a pressure-sensitive adhesive and a use thereof.

### BACKGROUND ART

A flexible device is a new conceptual device, and in an example thereof, a so-called foldable device or rollable device is included.

The pressure-sensitive adhesive layer applied to the foldable device is repeatedly folded and then unfolded, or wound and then unwound.

Therefore, the layer applied to the foldable device is required to be capable of effectively following the repeated deformation, and recovering to its original shape when the force applied during the deformation disappears.

In general, it is known that the lower the elastic modulus of the pressure-sensitive adhesive, particularly, the lower the elastic modulus at a low temperature, the more effectively it is to follow the repeated deformation as above.

However, when the elastic modulus of the pressure-sensitive adhesive layer is too low, there are problems that the property of recovering when the force applied for deformation disappears is deteriorated, and the cuttability and workability are deteriorated.

Therefore, in consideration of cuttability or workability, it may be preferable that the pressure-sensitive adhesive layer has an elastic modulus of a certain level or more, but it is not easy to obtain a pressure-sensitive adhesive layer that effectively follows deformation while securing the desired level of recovery properties, cuttability and workability, and the like.

In addition, when the elastic modulus is increased in consideration of cuttability or workability, there is a problem that the peel force basically required for the pressure-sensitive adhesive layer is lowered.

Therefore, it is an uneasy task to provide a pressure-sensitive adhesive layer having physical properties suitable for a flexible device.

### DISCLOSURE

### Technical Problem

The present application relates to a pressure-sensitive adhesive. It is one object of the present application to provide a pressure-sensitive adhesive suitable for a flexible device. In one example, it is one object of the present application to provide a pressure-sensitive adhesive capable of forming a pressure-sensitive adhesive layer that exhibits a relatively high elastic modulus at a high temperature while exhibiting a low elastic modulus at a low temperature, and simultaneously exhibits an appropriate level of adhesive force (peel force).

It is another object of the present application to provide a pressure-sensitive adhesive film or a flexible device comprising the pressure-sensitive adhesive.

### Technical Solution

Among the physical properties mentioned in this specification, when the measured temperature affects the relevant physical property, the physical property is a physical property measured at room temperature, unless otherwise specified.

In this specification, the term room temperature is a temperature in a state where it is not particularly warmed and cooled, which may mean any one temperature within the range of about 10° C. to 30° C., for example, a temperature of about 27° C. or less while being about 15° C. or more, 18° C. or more, 20° C. or more, or about 23° C. or more. In addition, unless otherwise specified, the unit of temperature mentioned in this specification is ° C.

Among the physical properties mentioned in this specification, when the measured pressure affects the relevant physical property, the physical property is a physical property measured at normal pressure, unless otherwise specified.

In this specification, the term normal pressure is a pressure in a state where it is not particularly pressurized and depressurized, which usually means a pressure of about 740 mmHg to 780 mmHg or so, which is the atmospheric pressure level.

Among the physical properties mentioned in this specification, when the measured humidity affects the relevant physical property, the physical property is a physical property measured at natural humidity in the state of the room temperature and normal pressure, unless otherwise specified.

The present application relates to a pressure-sensitive adhesive. The pressure-sensitive adhesive of the present application may comprise an acrylic copolymer.

In this specification, the term copolymer means a resulting product of a polymerization reaction of a monomer mixture. In this specification, the term monomer unit means the state of the monomer after the polymerization reaction.

In this specification, the term acrylic copolymer is a copolymer comprising an acrylic monomer unit as a main component. The lower limit of the ratio of the acrylic monomer unit in the acrylic copolymer may be 50 wt %, 55 wt %, 60 wt %, 65 wt %, 70 wt %, 75 wt %, 80 wt %, 85 wt %, 90 wt %, or 95 wt % or so, and the upper limit thereof may be 100 wt %, 99 wt %, 98 wt %, 97 wt %, 96 wt %, or 95 wt % or so. The ratio may be within a range of more than or equal to, or more than any one of the above-described lower limits; within a range of less than or equal to, or less than any one of the above-described upper limits; or within a range of less than or equal to, or less than any one of the above-described upper limits while being more than or equal to, or more than any one of the above-described lower limits.

In this specification, the term acrylic monomer means acrylic acid or methacrylic acid, or a derivative of the acrylic acid or methacrylic acid (e.g., acrylic acid ester or methacrylic acid ester).

In this specification, the term (meth)acryl means acryl or methacryl.

When the acrylic copolymer is cross-linkable in the pressure-sensitive adhesive of the present application, the acrylic copolymer may be in a state before cross-linking or after cross-linking, and may suitably be in a cross-linked state. Therefore, the pressure-sensitive adhesive may comprise the cross-linked acrylic copolymer.

Accordingly, the present application may be related to a pressure-sensitive adhesive comprising a cross-linked acrylic copolymer and having a storage elastic modulus at a low temperature (−20° C.) and a peel force to glass, and haze, as described below.

In addition, the present application may be related to a pressure-sensitive adhesive comprising a cross-linked acrylic copolymer, and having haze to be described below while exhibiting temperature-dependent change characteristics of storage moduli as described below.

Furthermore, the present application may be related to a pressure-sensitive adhesive comprising a cross-linked acrylic copolymer, and a compound of Formula 1 to be described below.

The pressure-sensitive adhesive may comprise the acrylic copolymer as the main component. For example, the lower limit of the ratio of the acrylic copolymer based on the total weight of the pressure-sensitive adhesive may be 50 wt %, 55 wt %, 60 wt %, 65 wt %, 70 wt %, 75 wt %, 80 wt %, 85 wt %, 90 wt %, 95 wt %, 97 wt %, or 99 wt % or so, and the upper limit thereof may be 100 wt %, 99 wt %, 98 wt %, 97 wt %, 96 wt %, or 95 wt % or so. The ratio may be within a range of more than or equal to, or more than any one of the above-described lower limits; within a range of less than or equal to, or less than any one of the above-described upper limits; or within a range of less than or equal to, or less than any one of the above-described upper limits while being more than or equal to, or more than any one of the above-described lower limits. When the pressure-sensitive adhesive comprises a component, such as a solvent or a thinner, that is not included in the final pressure-sensitive adhesive layer, the content of the acrylic copolymer is the content in the pressure-sensitive adhesive excluding the component not included in the final pressure-sensitive adhesive layer.

The storage elastic modulus and peel force of the pressure-sensitive adhesive mentioned in this specification are the storage elastic modulus and peel force in a state where the pressure-sensitive adhesive composition is cross-linked (that is, the acrylic copolymer included in the pressure-sensitive adhesive composition is cross-linked), which may thus be the storage elastic modulus and peel force of the pressure-sensitive adhesive or pressure-sensitive adhesive layer.

The pressure-sensitive adhesive of the present application may exhibit a low storage elastic modulus at a low temperature.

In this specification, the storage elastic modulus is a result measured in the manner presented in the following examples.

For example, in the pressure-sensitive adhesive, the upper limit of the storage modulus at −20° C. may be 100,000 Pa, 98,000 Pa, 96,000 Pa, 95,000 Pa, 94,000 Pa, 93,000 Pa, 92,000 Pa, 90,000 Pa, 88,000 Pa, 86,000 Pa, 85,000 Pa, or 84,000 Pa or so, and the lower limit thereof may be, for example, 30,000 Pa, 40,000 Pa, 42,000 Pa, 44,000 Pa, 45,000 Pa, 46,000 Pa, 48,000 Pa, 50,000 Pa, 52,000 Pa, 54,000 Pa, 55,000 Pa, 56,000 Pa, 58,000 Pa, 60,000 Pa, 62,000 Pa, 64,000 Pa, 65,000 Pa, 66,000 Pa, 68,000 Pa, 70,000 Pa, 72,000 Pa, 74,000 Pa, 75,000 Pa, 76,000 Pa, 78,000 Pa, 80,000 Pa, 82,000 Pa, 84,000 Pa, 86,000 Pa, 88,000 Pa, 90,000 Pa, 92,000 Pa, 94,000 Pa, or 96,000 Pa or so. The storage elastic modulus at −20° C. may be within a range of less than or equal to, or less than any one of the above-described upper limits; or within a range of less than or equal to, or less than any one of the above-described upper limits while being more than or equal to, or more than any one of the above-described lower limits.

By exhibiting the storage elastic modulus of the above range at −20° C., which is a low temperature, the pressure-sensitive adhesive can be applied to a flexible device to effectively respond to repeated deformation and recovery.

The pressure-sensitive adhesive of the present application may exhibit the low storage elastic modulus at a low temperature and simultaneously exhibit a high storage elastic modulus of a certain level or more at a relatively high temperature. The storage elastic modulus of the pressure-sensitive adhesive is a temperature-defendant function, and usually, when the temperature increases, the storage elastic modulus decreases. Therefore, the storage elastic modulus of the pressure-sensitive adhesive at high temperatures is usually lower than the storage elastic modulus at low temperatures. However, when the pressure-sensitive adhesive has a low storage elastic modulus at a low temperature, the storage elastic modulus at a high temperature is also relatively lowered, so that the storage elastic modulus at a high temperature of the pressure-sensitive adhesive having a low storage elastic modulus at a low temperature is lower than the storage elastic modulus at a high temperature of the pressure-sensitive adhesive having a high storage elastic modulus at a low temperature.

However, in the present application, it may exhibit a relatively high storage elastic modulus at a high temperature together with the low storage elastic modulus at a low temperature. That is, the pressure-sensitive adhesive of the present application may exhibit a relatively gentle slope in the graph of the storage elastic modulus according to temperature.

For example, the pressure-sensitive adhesive of the present application may have an elastic modulus change rate according to Equation 1 below in a predetermined range.

$$Elastic modulus change rate = ( M 20 - M 25 ) / 45 \qquad [ Equation l ]$$

In Equation 1, M20 is a storage elastic modulus (unit: Pa) of the pressure-sensitive adhesive at −20° C., and M25 is a storage elastic modulus (unit: Pa) of the pressure-sensitive adhesive at 25° C.

The upper limit of the elastic modulus change rate may be 2500, 2400, 2300, 2200, 2100, 2000, 1900, 1800, 1700, 1600, 1500, 1400, 1300, 1200, or 1100 or so, and the lower limit thereof may be 100, 200, 300, 400, 500, 600, 700, 800, 900, 1000, 1100, or 1200 or so. The elastic modulus change rate may be within a range of less than or equal to, or less than any one of the above-described upper limits; or within a range of less than or equal to, or less than any one of the above-described upper limits while being more than or equal to, or more than any one of the above-described lower limits.

The pressure-sensitive adhesive layer exhibiting such an elastic modulus change rate can effectively follow the repeated deformation and recovery in a foldable device, and maintain excellent workability and cuttability. However, as described above, the pressure-sensitive adhesive having a low elastic modulus at a low temperature exhibits a relatively low elastic modulus even at a high temperature, so that it is an uneasy task to satisfy the elastic modulus change rate. In the present application, by applying a predetermined acrylic copolymer to be described below as the acrylic copolymer, it is possible to satisfy such an elastic modulus change rate.

The lower limit of the storage elastic modulus of the pressure-sensitive adhesive at 25° C. may be 10,000 Pa, 12,000 Pa, 13,000 Pa, 14,000 Pa, 15,000 Pa, 16,000 Pa, 17,000 Pa, 18,000 Pa, 20,000 Pa, 21,000 Pa, 22,000 Pa, 23,000 Pa, 24,000 Pa, 26,000 Pa, 28,000 Pa, 30,000 Pa, 32,000 Pa, 34,000 Pa, 36,000 Pa, or 38,000 Pa or so, and the upper limit thereof may be, for example, about 100,000 Pa, 98,000 Pa, 96,000 Pa, 94,000 Pa, 92,000 Pa, 90,000 Pa, 88,000 Pa, 86,000 Pa, 84,000 Pa, 82,000 Pa, 80,000 Pa, 78,000 Pa, 76,000 Pa, 74,000 Pa, 72,000 Pa, 70,000 Pa, 68,000 Pa, 66,000 Pa, 64,000 Pa, 62,000 Pa, 60,000 Pa, 58,000 Pa, 56,000 Pa, 54,000 Pa, 52,000 Pa, 50,000 Pa, 48,000 Pa, 46,000 Pa, 44,000 Pa, 42,000 Pa, 40,000 Pa, 38,000 Pa, or 36,000 Pa or so. The storage elastic modulus at 25° C. may be within a range of more than or equal to, or more than any one of the above-described lower limits; or within a range of less than or equal to, or less than any one of the above-described upper limits while being more than or equal to, or more than any one of the above-described lower limits.

The pressure-sensitive adhesive of the present application may exhibit a relatively high high-temperature elastic modulus as above and simultaneously exhibit a high peel force. For example, the pressure-sensitive adhesive may have a room-temperature peel force to glass in a predetermined range.

The room-temperature peel force is a peel force measured at about 25° C., and a method for measuring this peel force is described in Examples.

The lower limit of the peel force may be, for example, about 1,700 gf/inch, 1,800 gf/inch, 1,900 gf/inch, 2,000 gf/inch, 2,100 gf/inch, 2,200 gf/inch, 2,300 gf/inch, or 2,400 gf/inch or so, and the upper limit thereof may be 5,000 gf/inch, 4,500 gf/inch, 4,000 gf/inch, 3,500 gf/inch, 3,000 gf/inch, 2,800 gf/inch, 2,600 gf/inch, 2,500 gf/inch, or 2,400 gf/inch or so. The peel force may be within a range of more than or equal to, or more than any one of the above-described lower limits; or within a range of less than or equal to, or less than any one of the above-described upper limits while being more than or equal to, or more than any one of the above-described lower limits.

In a flexible device, the pressure-sensitive adhesive having such storage elastic modulus and peel force effectively responds to repeated deformation and recovery, causes no defects (e.g., observation of deformation traces, etc.) before and after deformation, having excellent cuttability and workability, and causes no lifting, delamination and/or bubble generation.

The pressure-sensitive adhesive can exhibit excellent optical transparency. For example, the upper limit of the haze of the pressure-sensitive adhesive may be 0.5%, 0.45%, 0.4%, 0.35%, 0.3%, 0.25%, or 0.2% or so, and the lower limit thereof may be 0.1%, 0.15%, 0.2%, 0.25%, 0.3%, or 0.35% or so. The haze may be within a range of less than or equal to, or less than any one of the above-described upper limits; or within a range of less than or equal to, or less than any one of the above-described upper limits while being more than or equal to, or more than any one of the above-described lower limits.

In the present application, a specific acrylic copolymer is applied to form such a pressure-sensitive adhesive having specific physical properties.

The acrylic copolymer may comprise at least an alkyl (meth)acrylate unit, a unit of Formula 3 below, and a polar functional group-containing unit. The copolymer may further comprise a unit of Formula 4 below as an optional monomer unit, if necessary.

Here, the unit means a monomer unit.

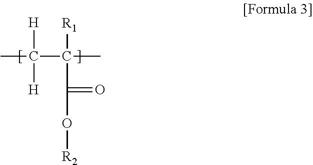

In Formula 3, R₁ represents hydrogen or an alkyl group, and R₂ represents an alkyl group with 11 to 13 carbon atoms.

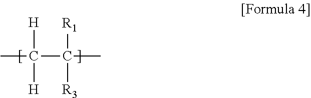

In Formula 4, R₁ represents hydrogen or an alkyl group, and R₃ represents an aromatic ketone group or a (meth)acryloyl group.

The acrylic copolymer comprising the monomer units is effective in forming a desired pressure-sensitive adhesive.

The acrylic copolymer is formed as a so-called crystalline copolymer under a predetermined ratio of the unit of Formula 3 above and/or the polar functional group-containing unit, or has properties like those of the crystalline copolymer. In this specification, the term crystalline copolymer means a copolymer whose melting point is identified in a predetermined range in the DSC (Differential Scanning calorimeter) measurement method described in Examples of this specification.

The acrylic copolymers are known as amorphous copolymers. However, when the unit of Formula 3 above is present in a predetermined ratio, and in some cases, when the unit of Formula 3 above interacts with the polar functional group present in a predetermined ratio, such a copolymer may exhibit crystallinity, or may exhibit at least properties like crystallinity. As such, when a copolymer having crystallinity or exhibiting properties like crystallinity is applied, the pressure-sensitive adhesive having the above-described properties can be efficiently formed. Therefore, it is possible to effectively form a pressure-sensitive adhesive layer exhibiting the above-described elastic modulus and peel force characteristics through the pressure-sensitive adhesive to which such a copolymer is applied.

As the alkyl (meth)acrylate unit contained in the copolymer, for example, a unit derived from an alkyl (meth)acrylate having an alkyl group with 1 to 10 carbon atoms may be used. In another example, the alkyl group may be an alkyl group with 2 to 20 carbon atoms, 3 to 10 carbon atoms, 4 to 10 carbon atoms, 4 to 9 carbon atoms, or 4 to 8 carbon atoms. The alkyl group may be linear or branched, which may be substituted or unsubstituted. In one example, the unit may be formed using an alkyl (meth)acrylate having an unsubstituted alkyl group while being linear or branched as the alkyl group.

An example of the alkyl (meth)acrylate may be exemplified by methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl(meth)acrylate, 2-ethylhexyl (meth)acrylate, 2-ethylbutyl(meth)acrylate, isononyl (meth)acrylate, n-octyl (meth)acrylate or isooctyl (meth)acrylate, and the like, but is not limited thereto.

In the acrylic copolymer, the lower limit of the weight ratio of the alkyl (meth)acrylate unit may be 10 wt %, 15 wt %, 20 wt %, 25 wt %, 30 wt %, 35 wt %, 40 wt %, 45 wt %, 50 wt %, or 55 wt % or so, and the upper limit thereof may also be 80 wt %, 75 wt %, 70 wt %, or 65 wt % or so. The ratio may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits. Within such a range, a desired pressure-sensitive adhesive may be effectively formed.

The polar functional group-containing unit is a unit formed of a monomer having a polar functional group. Such a monomer usually comprises a polymerizable group (e.g., a carbon-carbon double bond) and a polar functional group simultaneously.

The monomer having a polar functional group may include a hydroxyl group-containing monomer, a carboxyl group-containing monomer, and a nitrogen-containing monomer, and the like, ad in the present application, it is particularly advantageous to apply a hydroxyl group-containing monomer, but is not limited thereto.

The hydroxyl group-containing monomer may include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl(meth)acrylate, 2-hydroxypolyethylene glycol (meth)acrylate, or 2-hydroxypolypropylene glycol (meth)acrylate, and the like: an example of the carboxyl group-containing monomer may include (meth)acrylic acid, 2-(meth)acryloyloxyacetic acid, 3-(meth)acryloyloxypropyl acid, 4-(meth)acryloyloxybutyric acid, acrylic acid dimer, itaconic acid, maleic acid and maleic acid anhydride, and the like; and an example of the nitrogen-containing monomer may include (meth)acrylamide, N-vinyl pyrrolidone, or N-vinyl caprolactam, and the like, without being limited thereto. One or a mixture of two or more of the foregoing may be used.

The weight ratio of the polar functional group-containing unit relative to 100 parts by weight of the alkyl (meth)acrylate unit may be adjusted within a range capable of stably maintaining the durability, tackiness, and peel force of the pressure-sensitive adhesive layer. For example, the lower limit of the weight ratio of the polar functional group-containing unit relative to 100 parts by weight of the alkyl (meth)acrylate unit may be 1 part by weight, 5 parts by weight, 10 parts by weight, or 15 parts by weight or so, and the upper limit thereof may be 100 parts by weight, 95 parts by weight, 90 parts by weight, 85 parts by weight, 80 parts by weight, 75 parts by weight, 70 parts by weight, 65 parts by weight, 60 parts by weight, 55 parts by weight, 50 parts by weight, 45 parts by weight, 40 parts by weight parts, 35 parts by weight, 30 parts by weight, 25 parts by weight, or 20 parts by weight or so.

The unit of Formula 3 is a unit containing a long-chain alkyl group, and such a unit is included in the copolymer in a certain ratio or more, and interacts with a polar functional group as necessary, whereby it is possible to impart crystallinity or properties like crystallinity to the copolymer.

In the unit of Formula 3, R₁ may be hydrogen or an alkyl group with 1 to 4 carbon atoms, and may be specifically hydrogen, or a methyl or ethyl group.

In Formula 3, R₂ is an alkyl group with 11 to 13 carbon atoms, where such an alkyl group may be linear or branched, and may be substituted or unsubstituted. In one example, the R₂ may be an unsubstituted alkyl group while being linear. For example, the unit of Formula 3 may be formed using lauryl (meth)acrylate and/or tetradecyl(meth)acrylate, and the like.

The lower limit of the weight ratio of the unit of Formula 3 above relative to 100 parts by weight of the alkyl (meth)acrylate unit may be 10 parts by weight, 15 parts by weight, 20 parts by weight, 25 parts by weight, 30 parts by weight, 35 parts by weight, 40 parts by weight, 45 parts by weight, or 50 parts by weight or so, and the upper limit thereof may be 300 parts by weight, 280 parts by weight, 260 parts by weight, 240 parts by weight, 220 parts by weight, 200 parts by weight, 180 parts by weight, 160 parts by weight, 140 parts by weight, 120 parts by weight, 100 parts by weight, 90 parts by weight, 80 parts by weight, 70 parts by weight, 65 parts by weight, 60 parts by weight, 55 parts by weight, or 50 parts by weight or so. The ratio may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits.

The unit of Formula 4 that may be included as an optional monomer unit in the acrylic copolymer is a unit comprising an aromatic ketone group or a (meth)acryloyl group in a side chain.

The aromatic ketone group or (meth)acryloyl group in the pressure-sensitive adhesive may exist as such, or may also exist in a state after undergoing a hydrogen removal reaction or radical reaction described below.

The aromatic ketone group in the unit of Formula 4 means an aromatic ketone group that induces hydrogen removal (hydrogen abstraction) from a polymer chain when exposed to electromagnetic waves, or a substituent containing such an aromatic ketone group.

When exposed to electromagnetic waves, the aromatic ketone group can remove hydrogen atoms from other polymer chains or from other parts of the polymer chain. This removal results in the formation of radicals, where the radicals can form cross-links between polymer chains or within the same polymer chain. In the category of such aromatic ketone groups, for example, aromatic ketone groups such as derivatives of benzophenone, acetophenone, or anthraquinone are included.

The monomer capable of deriving the unit of Formula 4 having an aromatic ketone group includes 4-benzoylphenyl (meth)acrylate, 4-(meth)acryloyloxyethoxybenzophenone, 4-(meth)acryloyloxy-4′-methoxybenzophenone, 4-(meth)acryloyloxyethoxy-4′-methoxybenzophenone, 4-(meth)acryloyloxy-4′-bromobenzophenone and/or 4-acryloyloxyethoxy-4′-bromobenzophenone, and the like, but is not limited thereto.

The (meth)acryloyl group in the unit of Formula 4 means a (meth)acryloyl group that induces free radical polymerization when exposed to electromagnetic waves in the presence of an appropriate radical initiator, or a substituent comprising the same. Such a (meth)acryloyl group may act similarly to the aromatic ketone group by irradiation with electromagnetic waves.

The unit of Formula 4 in which R₃ is a (meth)acryloyl group, for example, may be formed by preparing a precursor copolymer and then further reacting it with an unsaturated reagent compound to introduce a (meth)acryloyl group. Typically, the introduction of the (meth)acryloyl group involves (1) a reaction between a nucleophilic group on the precursor copolymer and an electrophilic group on the unsaturated reagent compound (i.e., the unsaturated reagent compound contains both an electrophilic group and a (meth)acryloyl group), or (2) a reaction between an electrophilic group on the precursor copolymer and a nucleophilic group on the unsaturated reagent compound (i.e., the unsaturated reagent compound contains both nucleophilic groups and (meth)acryloyl groups). These reactions between nucleophilic groups and electrophilic groups are typically ring opening reactions, addition reactions or condensation reactions.

In this case, the precursor copolymer has a hydroxy, carboxylic acid (—COOH), or anhydride (—O—(CO)—O—) group. When the precursor copolymer has a hydroxyl group, the unsaturated reagent compound often has a carboxylic acid (—COOH), isocyanato (—NCO), epoxy (i.e., oxiranyl) or anhydride group in addition to the (meth)acryloyl group. When the precursor copolymer has a carboxylic acid group, the unsaturated reagent compound often has a hydroxy, amino, epoxy, isocyanato, aziridinyl, azetidinyl, or oxazolinyl group in addition to the (meth)acryloyl group. When the precursor (meth)acrylate copolymer has an anhydride group, the unsaturated reagent compound often has a hydroxy or amine group in addition to the (meth)acryloyl group.

In one example, the precursor copolymer may have a carboxylic acid group and the unsaturated reagent compound may have an epoxy group. In an exemplary unsaturated reagent compound, for example, glycidyl (meth)acrylate and 4-hydroxybutyl acrylate glycidyl ether are included. In another example, the precursor copolymer has an anhydride group, and reacts with an unsaturated reagent compound which is a hydroxy-substituted alkyl (meth)acrylate, such as 2-hydroxyethyl (meth)acrylate, 3-hydroxypropyl (meth)acrylate, and the like. In another example, the precursor copolymer has a hydroxy group and the unsaturated reagent compound has an isocyanato group and a (meth)acryloyl group. Such an unsaturated reagent compound comprises an isocyanatoalkyl (meth)acrylate, such as isocyanatoethyl (meth)acrylate, but is not limited thereto.

In one example, the (meth)acryloyl group may be represented by the formula CH₂═CHR¹—(CO)-Q-L-(wherein, L is a linking group and Q is oxy (—O—) or —NH—). Here, L comprises alkylene, arylene, or a combination thereof, and further comprises-O—, —O—(CO)—, —NH—(CO)—, —NH—, or a combination thereof, optionally depending on the precursor copolymer and the specific unsaturated reagent compound, which are reacted to form the (meth)acryloyl group. In some specific examples, the (meth)acryloyl group is H₂C═CHR¹ (CO)—O—R₆⁻NH—(CO)—O—R₅⁻O—(CO)—, which is formed by a reaction of a hydroxy-containing group of the precursor copolymer represented by the formula —(CO)—O—R₅—OH and the unsaturated reagent compound which is an isocyanatoalkyl (meth)acrylate represented by the formula H₂C═CHR¹ (CO)—O—R₆⁻NCO. Here, R₅ and R₆ are each independently an alkylene group, for example, alkylene having 1 to 10 carbon atoms, 1 to 6 carbon atoms, or 1 to 4 carbon atoms. In addition, here, R₁ is methyl or hydrogen.

In the unit of Formula 4, R₁ may be hydrogen or an alkyl group with 1 to 4 carbon atoms, and specifically, may be hydrogen, or a methyl or ethyl group.

When the unit of Formula 4 is included, the lower limit of the weight ratio of the unit of Formula 4 relative to 100 parts by weight of the alkyl (meth)acrylate unit may be 0 parts by weight, 0.001 parts by weight, 0.003 parts by weight, 0.005 parts by weight, 0.007 parts by weight, 0.009 parts by weight, 0.01 parts by weight, 0.015 parts by weight, 0.02 parts by weight, 0.025 parts by weight, 0.03 parts by weight, 0.035 parts by weight, 0.04 parts by weight, 0.045 parts by weight, 0.05 parts by weight, 0.055 parts by weight, 0.06 parts by weight parts, 0.065 parts by weight, 0.07 parts by weight, 0.075 parts by weight, 0.08 parts by weight, 0.085 parts by weight, 0.09 parts by weight, or 0.1 parts by weight or so, and the upper limit thereof may be 5 parts by weight, 4.5 parts by weight, 4 parts by weight, 3.5 parts by weight, 3 parts by weight, 2.5 parts by weight, 2 parts by weight, 2 parts by weight, 1.5 parts by weight, 1 part by weight, 0.5 parts by weight, 0.3 parts by weight, 0.1 parts by weight, 0.08 parts by weight, 0.06 parts by weight, 0.04 parts by weight, or 0.02 parts by weight or so. The ratio may be within a range of more than or equal to, or more than any one of the above-described lower limits; within a range of less than or equal to, or less than any one of the above-described upper limits; or within a range of less than or equal to, or less than any one of the above-described upper limits while being more than or equal to, or more than any one of the above-described lower limits. Under this ratio, it is possible to effectively form the desired pressure-sensitive adhesive layer by irradiation of electromagnetic waves.

The acrylic copolymer may appropriately contain other monomer units in addition to the above-described monomer units, if the purpose is not impaired (for example, the crystallinity of the copolymer is not impaired).

In one example, the acrylic copolymer included in the pressure-sensitive adhesive may be a crystalline acrylic copolymer. As described above, the term crystalline copolymer means a copolymer whose melting point is identified in a predetermined range in the DSC (Differential Scanning calorimeter) measurement method described in Examples of this specification.

In one example, the upper limit of the melting point of the acrylic copolymer confirmed in the above manner may be −20° C., −25° C., −30° C., −35° C., or −40° C. or so, and the lower limit thereof may be −100° C., −95° C., −90° C., −85° C., −80° C., −75° C., −70° C., −65° C., −60° C., −55° C., −50° C., or −45° C. or so. The melting point may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits. The acrylic copolymer having such a melting point may form the desired pressure-sensitive adhesive effectively.

The specific composition of the crystalline acrylic copolymer is not particularly limited. In one example, the crystalline acrylic copolymer may be a copolymer including at least the above-described three types of units (alkyl (meth)acrylate unit, unit of Formula 3, and polar functional group-containing unit). However, all the above-described acrylic copolymers do not exhibit crystallinity. In order that the acrylic copolymer may exhibit crystallinity, it is necessary to include the unit of Formula 3 among the above-described units in a certain level or more. In the crystalline acrylic copolymer, the lower limit of the weight ratio of the unit of Formula 3 relative to 100 parts by weight of the alkyl (meth)acrylate unit may be 15 parts by weight, 20 parts by weight, 25 parts by weight, 30 parts by weight, 35 parts by weight, 40 parts by weight, 45 parts by weight, 50 parts by weight, 55 parts by weight, or 60 parts by weight or so, and the upper limit thereof may also be 300 parts by weight, 250 parts by weight, 200 parts by weight, 150 parts by weight, 100 parts by weight, 90 parts by weight, 80 parts by weight, 70 parts by weight, 60 parts by weight, or 50 parts by weight or so. The ratio may be within a range of more than or equal to, or more than any one of the above-described lower limits; or within a range of less than or equal to, or less than any one of the above-described upper limits while being more than or equal to, or more than any one of the above-described lower limits.

In the crystalline acrylic copolymer, the lower limit of the ratio (A/B) of the weight (A) of the unit of Formula 3 to the weight (B) of the polar functional group-containing unit may be 1.5, 2, 2.5, or 3 or so, and the upper limit thereof may be 10, 9, 8, 7, 6, 5, 4, or 3 or so. The ratio may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits.

In the crystalline acrylic copolymer, the polar functional group-containing unit may be a hydroxy group-containing unit. In one example, a hydroxyalkyl (meth)acrylate having a hydroxyalkyl group having a carbon number in a predetermined range may appropriately form the crystalline acrylic copolymer. Although the reason is not clear, it is thought that the interaction between the alkyl group (R₂) of the unit of Formula 3 and the hydroxyalkyl group contributes to the expression of crystallinity of the acrylic copolymer. The lower limit of the carbon number in the hydroxyalkyl group may be 3, or 4 or so, and the upper limit thereof may also be 10, 9, 8, 7, 6, 5, or 4 or so. The carbon number may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits.

In the crystalline acrylic copolymer, the lower limit of the ratio of the alkyl (meth)acrylate unit may be 20 wt %, 25 wt %, 30 wt %, 35 wt %, 40 wt %, 45 wt %, 50 wt %, 55 wt %, or 60 wt % or so, and the upper limit thereof may also be 70 wt %, 65 wt %, or 60 wt % or so. The ratio may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits. Within this range, it is possible to effectively form the desired pressure-sensitive adhesive layer.

Although the reason is not clear, it is thought that the crystallinity is provided to the acrylic copolymer and the melting point is identified by the interaction or regularity of the respective monomer units contained in the ratio.

As the acrylic copolymer, a copolymer having a weight average molecular weight in a certain level or more may be used. In this specification, the weight average molecular weight means a polystyrene conversion value measured by GPC (gel permeation chromatography). In addition, unless otherwise specified, the unit of the weight average molecular weight is g/mol. The lower limit of the weight average molecular weight of the copolymer may be 1,000,000, 1,100,000, 1,200,000, 1,300,000, 1,400,000, 1,500,000, 1,600,000, 1,700,000, 1,800,000, 1,900,000, or 2,000,000 or so, and the upper limit thereof may be 5,000,000, 4,000,000, 3,000,000, 2,500,000, or 2,000,000 or so. The weight average molecular weight may be within a range of more than or equal to, or more than any one of the above-described lower limits; within a range of less than or equal to, or less than any one of the above-described upper limits; or within a range of less than or equal to, or less than any one of the above-described upper limits while being more than or equal to, or more than any one of the above-described lower limits.

The lower the weight average molecular weight of the copolymer, the greater the change in physical properties after cross-linking, but if the weight average molecular weight is too low, it is disadvantageous in terms of durability under high temperature and/or high humidity conditions. However, in the case of the present application, by using the above-described specific copolymers, it is possible to effectively form the desired pressure-sensitive adhesive layer even in a state where the weight average molecular weight is maintained at an appropriate level.

The acrylic copolymer may have a molecular weight distribution within a predetermined range. In addition, it may be appropriate that the acrylic copolymer is cross-linked by an appropriate cross-linking agent according to the molecular weight distribution to be included in the pressure-sensitive adhesive. The molecular weight distribution is the value (Mw/Mn) obtained by dividing the weight average molecular weight (Mw) by the number average molecular weight (Mn). In general, as the molecular weight distribution is smaller, it is recognized that the ratio of components with a relatively small molecular weight and components with a relatively high molecular weight, based on the average molecular weight, in the copolymer is small, the composition of the copolymer is uniform, and rheological properties such as an elastic modulus are stable. However, physical properties suitable for flexible devices include properties opposite to each other, such as followability and recoverability to deformation, and the followability, and cuttability and reliability, whereby to stably secure these properties, it may be necessary to adjust the molecular weight distribution depending on the type of the applied cross-linking agent.

In one example, when the acrylic copolymer is cross-linked by a thermal cross-linking agent to be described below and included, the lower limit of the molecular weight distribution may be 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or 5.0 or so, and the upper limit thereof may be 10, 9.5, 9, 8.5, 8, 7.5, 7, 6.5, 6, or 5.5 or so. The molecular weight distribution may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a thermal cross-linking agent to be described below. It may be appropriate for this type of acrylic copolymer to be cross-linked only by the thermal cross-linking agent. For example, when the acrylic copolymer is cross-linked only by the thermal cross-linking agent, or also cross-linked by simultaneously applying the thermal cross-linking agent and the radical cross-linking agent, it may be appropriate that the ratio (A/B) of the weight (A) of the used thermal cross-linking agent and the weight (B) of the radical cross-linking agent is below a certain level. For example, the upper limit of the weight ratio A/B may be 0.5, 0.4, 0.3, 0.2, 0.1, 0.09, 0.08, 0.07, 0.06, 0.05, 0.04, 0.03, 0.02, 0.01, 0.009, 0.008, 0.007, 0.006, 0.006 0.005, 0.004, 0.003, 0.002, 0.001, 0.0009, 0.0008, 0.0007, 0.0006, 0.0005, 0.0004, 0.0003, 0.0002, or 0.0001 or so, and the lower limit thereof may be 0 or so. The ratio A/B may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a radical cross-linking agent to be described below.

In one example, when the acrylic copolymer is cross-linked by a so-called radical cross-linking agent and included, the lower limit of the molecular weight distribution may be 0.5, 1, 1.5, or 2 or so, and the upper limit thereof may be 3, 2.8, 2.6, or 2.4 or so. The molecular weight distribution may be less than or equal to, or less than any one of the above-described upper limits, may be more than or equal to, or more than any one of the above-described lower limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a so-called radical cross-linking agent. It may be appropriate that the acrylic copolymer with such a type is cross-linked only by the radical cross-linking agent. For example, when the acrylic copolymer is cross-linked only by the radical cross-linking agent, or also cross-linked by simultaneously applying the thermal cross-linking agent and the radical cross-linking agent, it may be appropriate that the ratio (C/D) of the weight (C) of the used thermal cross-linking agent and the weight (D) of the radical cross-linking agent is below a certain level. For example, the upper limit of the weight ratio C/D may be 0.5, 0.4, 0.3, 0.2, 0.1, 0.09, 0.08, 0.07, 0.06, 0.05, 0.04, 0.03, 0.02, 0.01, 0.009, 0.008, 0.007, 0.006 0.005, 0.004, 0.003, 0.002, 0.001, 0.0009, 0.0008, 0.0007, 0.0006, 0.0005, 0.0004, 0.0003, 0.0002, or 0.0001 or so, and the lower limit thereof may be 0 or so. The ratio C/D may be less than or equal to, or less than any one of the above-described upper limits, or may be more than or equal to, or more than any one of the above-described lower limits while being less than or equal to, or less than any one of the above-described upper limits. It may be suitable for forming a desired type of pressure-sensitive adhesive that the acrylic copolymer with such a molecular weight distribution is cross-linked by a radical cross-linking agent to be described below.

A method of adjusting a molecular weight distribution of an acrylic copolymer itself is known, and for example, the molecular weight distribution may be controlled through one or more methods selected from use of a molecular weight regulator, adjustment of the ratio of the initiator, and/or adjustment of the polymerization time, and the like.

The pressure-sensitive adhesive may comprise a compound of Formula 1 below. The pressure-sensitive adhesive comprising such a compound can effectively satisfy the desired properties.

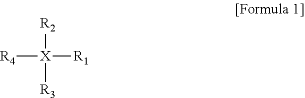

In Formula 1, X is carbon or nitrogen, R₁ to R₃ are each independently hydrogen, an alkyl group, or a hydroxy group, and when X is nitrogen, R₄ is not present, and at least one of R₁ to R₄ is a hydroxy group. In Formula 1, R₄ may be, when present, a substituent of Formula 2 below.

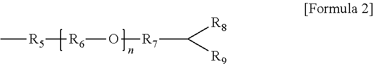

In Formula 2, R₅ is a single bond, an oxygen atom, -L₁-C(═O)-L₂-, -L₁-C(═O)—O-L₂-, or -L₁-O—C(═O)-L₂-; R₆ is an alkylidene group or an alkylene group, R₇ is a single bond, —O—C(═O)—, —C(═O)—, or —C(═O)—O—, and R₈ and R₉ are each independently hydrogen or an alkyl group, and n is a number in a range of 0 to 10.

In Formula 2, when R₇ is a single bond or —C(═O)—O—, R₉ is not present. Also, in Formula 2, L₁ and L₂ are each independently a single bond, an alkylidene group, or an alkylene group.

In Formula 1, when X is carbon, R₁ to R₃ may each independently be hydrogen or an alkyl group. The alkyl group may be an alkyl group with 1 to 20 carbon atoms, 1 to 16 carbon atoms, 1 to 12 carbon atoms, 1 to 8 carbon atoms, or 1 to 4 carbon atoms. Such an alkyl group may have a linear or branched structure, and may also be optionally substituted with one or more substituents.

In Formula 2, R₅ may be, in one example, an oxygen atom, —C(═O)—, —C(═O)—O—, or —O—C(═O)—.

The term alkylidene group is a divalent residue formed by removing two hydrogen atoms from one carbon atom in an alkane, and the alkylene group is a divalent residue formed by removing hydrogen atoms from two different carbon atoms in an alkane, respectively.

In Formula 2, the alkylidene group of R₆ may be an alkylidene group with 1 to 20 carbon atoms, 1 to 16 carbon atoms, 1 to 12 carbon atoms, 1 to 8 carbon atoms, or 1 to 4 carbon atoms. Such an alkylidene group may have a linear or branched structure, and may also be optionally substituted with one or more substituents.

In Formula 2, the alkylene group of R₆ may be an alkylene group with 2 to 20 carbon atoms, 2 to 16 carbon atoms, 2 to 12 carbon atoms, 2 to 8 carbon atoms, or 2 to 4 carbon atoms. Such an alkylene group may have a linear or branched structure, and may also be optionally substituted with one or more substituents.

In Formula 2, R₈ may be hydrogen or an alkyl group, and the alkyl group may be an alkyl group with 1 to 20 carbon atoms, 4 to 20 carbon atoms, 6 to 20 carbon atoms, 6 to 16 carbon atoms, 6 to 12 carbon atoms, or 6 to 8 carbon atoms. Such an alkyl group may have a linear or branched structure, and may also be optionally substituted with one or more substituents (e.g., an alkyl group).

In Formula 1, when X is nitrogen, R₁ and R₂ may each independently hydrogen or an alkyl group, where the alkyl group may be an alkyl group with 1 to 20 carbon atoms, 1 to 16 carbon atoms, 1 to 12 carbon atoms, 1 to 8 carbon atoms, or 1 to 4 carbon atoms. Such an alkyl group may have a linear or branched structure, and may also be optionally substituted with one or more substituents.

In Formula 1, when X is nitrogen, R₃ may be a hydroxy group.

When X in Formula 1 is carbon, n in Formula 2 may be 0, or may not be 0. When n is not 0, the lower limit of n may be 1, 2, or 3, and the upper limit thereof may be 10, 9, 8, 7, 6, 5, 4, or 3. When n is not 0, it may be less than or equal to, or less than any one of the above-described upper limits, or may be more than or equal to, or more than any one of the above-described lower limits, or may be more than or equal to, or more than any one of the above-described upper limits while being less than or equal to, or less than any one of the above-described upper limits.

In Formula 1, when X is carbon, R₁ to R₃ may each independently be hydrogen or an alkyl group. At this time, any one of R₁ to R₃ may be hydrogen, and the other two may be alkyl groups. At this time, the alkyl group may be an alkyl group with 1 to 20 carbon atoms, 1 to 16 carbon atoms, 1 to 12 carbon atoms, 1 to 8 carbon atoms, or 1 to 4 carbon atoms. Such an alkyl group may have a linear or branched structure, and may also be optionally substituted with one or more substituents. Also, when any one of R₁ to R₃ is hydrogen and the other two are alkyl groups, the carbon numbers of the two alkyl groups may be different from each other, or the same.

When X in Formula 1 is oxygen and n in Formula 2 is 0, R₅ in Formula 2 may be -L₁-C(═O)-L₂-, -L₁-C(═O)—O-L₂-, or -L₁-O—C(═O)-L₂-, and in this case, L₁ and L₂ may each independently be an alkylene group or an alkylidene group. The alkylidene group may be an alkylidene group with 1 to 20 carbon atoms, 1 to 16 carbon atoms, 1 to 12 carbon atoms, 1 to 8 carbon atoms, or 1 to 4 carbon atoms, and the alkylene group may be an alkylene group with 2 to 20 carbon atoms, 2 to 16 carbon atoms, or 2 to 12 carbon atoms, 2 to 8 carbon atoms, or 2 to 4 carbon atoms. Such an alkylene group or alkylidene group may have a linear or branched structure, and may also be optionally substituted with one or more substituents.

When X in Formula 1 is oxygen and n in Formula 2 is 0, R₇ in Formula 2 may be —O—C(═O)—, —C(═O)—, or —C(═O)—O—.

When X in Formula 1 is carbon and n in Formula 2 is 0, R₈ and R₉ in Formula 2 may each independently be hydrogen or an alkyl group, or may each independently be an alkyl group. In this case, the alkyl group may be an alkyl group with 1 to 20 carbon atoms, 1 to 16 carbon atoms, 1 to 12 carbon atoms, 1 to 8 carbon atoms, or 1 to 4 carbon atoms. Such an alkyl group may have a linear or branched structure, and may also be optionally substituted with one or more substituents. Also, when R₈ and R₉ are each independently an alkyl group, their carbon numbers may be the same, or different from each other.

When X in Formula 1 is oxygen and n in Formula 2 is not 0, R₅ in Formula 2 may be -L₁-C(═O)-L₂-, -L₁-C(═O)—O-L₂-, or -L₁-O—C(═O)-L₂-, and in this case, L₁ and L₂ may each be a single bond.

When X in Formula 1 is oxygen and n in Formula 2 is not 0, the alkylidene group in R₆ of Formula 2 may be an alkylidene group with 1 to 20 carbon atoms, 1 to 16 carbon atoms, 1 to 12 carbon atoms, 1 to 8 carbon atoms, or 1 to 4 carbon atoms, and the alkylene group may be an alkylene group with 2 to 20 carbon atoms, 2 to 16 carbon atoms, 2 to 12 carbon atoms, 2 to 8 carbon atoms, or 2 to 4 carbon atoms. Such an alkylene group or alkylidene group may have a linear or branched structure, and may also be optionally substituted with one or more substituents.

When X in Formula 1 is carbon and n in Formula 2 is not 0, R₇ in Formula 2 may be —O—C(═O)—, —C(═O)—, or —C(═O)—O—.

When X in Formula 1 is carbon and n in Formula 2 is not 0, R₈ and R₉ in Formula 2 may each independently be hydrogen or an alkyl group, or may each independently an alkyl group. In this case, the alkyl group may be an alkyl group with 1 to 20 carbon atoms, 1 to 16 carbon atoms, 1 to 12 carbon atoms, 1 to 8 carbon atoms, or 1 to 4 carbon atoms. Such an alkyl group may have a linear or branched structure, and may also be optionally substituted with one or more substituents. Also, when R₈ and R₉ are each independently an alkyl group, their carbon numbers may be the same, or different from each other.

In the pressure-sensitive adhesive, the compound of Formula 1 may be included in an amount of 0.1 parts by weight to 50 parts by weight relative to 100 parts by weight of the acrylic copolymer. Within the range, the pressure-sensitive adhesive layer can exhibit desired properties such as storage elastic modulus and peel force. In another example, the ratio may be about 0.2 parts by weight or more, about 0.3 parts by weight or more, about 0.4 parts by weight or more, about 0.5 parts by weight or more, 0.6 parts by weight or more, 0.7 parts by weight or more, 0.8 parts by weight or more, 0.9 parts by weight or more, 1 part by weight or more, 2 parts by weight or more, 3 parts by weight or more, 4 parts by weight or more, 5 parts by weight or more, 6 parts by weight or more, 7 parts by weight or more, 8 parts by weight or more, 9 parts by weight or more, or 10 parts by weight or more, or may also be about 45 parts by weight or less, 40 parts by weight or less, 35 parts by weight or less, 30 parts by weight or less, 25 parts by weight or less, 20 parts by weight or less, about 15 parts by weight or less, or 10 parts by weight or less or so.

The pressure-sensitive adhesive may further comprise a cross-linking agent. The cross-linking agent may react with the acrylic copolymer to implement a cross-linking structure.

The type of the cross-linking agent is not particularly limited, and for example, a general cross-linking agent such as an isocyanate-based compound, an epoxy-based compound, an aziridine-based compound, and a metal chelate-based compound may be used. This type of cross-linking agent is a so-called thermal cross-linking agent that implements a cross-linked structure by application of heat, and is different from a radical cross-linking agent to be described below. A specific example of the isocyanate-based compound may include one or more selected from the group consisting of tolylene diisocyanate, xylene diisocyanate, diphenylmethane diisocyanate, hexamethylene diisocyanate, isoborone diisocyanate, tetramethylxylene diisocyanate, naphthalene diisocyanate, and a reactant of any one of the foregoing with a polyol (e.g., trimethylol propane): a specific example of the epoxy compound may include one or more selected from the group consisting of ethylene glycol diglycidyl ether, triglycidyl ether, trimethylolpropane triglycidyl ether, N,N,N′,N′-tetraglycidyl ethylenediamine and glycerin diglycidyl ether; and a specific example of the aziridine-based compound may include one or more selected from the group consisting of N,N′-toluene-2,4-bis(1-aziridinecarboxamide), N,N′-diphenylmethane-4,4′-bis(1-aziridinecarboxamide), triethylene melamine, bisisoprotaloyl-1-(2-methylaziridine), and tri-1-aziridinylphosphine oxide, without being limited thereto. In addition, here, a specific example of the metal chelate-based compound may include a compound in which a polyvalent metal such as aluminum, iron, zinc, tin, titanium, antimony, magnesium and/or vanadium is coordinated with acetyl acetone or ethyl acetoacetate, and the like, but is not limited thereto.

In the pressure-sensitive adhesive layer, the lower limit of the weight ratio of the cross-linking agent relative to 100 parts by weight of the acrylic copolymer may be 0.01 parts by weight, 0.02 parts by weight, about 0.03 parts by weight, about 0.04 parts by weight, about 0.05 parts by weight, 0.06 parts by weight, 0.07 parts by weight, 0.08 parts by weight, or 0.09 parts by weight or so, and the upper limit thereof may also be about 10 parts by weight, 9 parts by weight, 8 parts by weight, 7 parts by weight, 6 parts by weight, 5 parts by weight, 4 parts by weight, about 3 parts by weight, about 2 parts by weight, about 1 part by weight, about 0.8 parts by weight, about 0.6 parts by weight, about 0.4 parts by weight, about 0.2 parts by weight, about 0.15 parts by weight, about 0.1 parts by weight, 0.09 parts by weight, 0.08 parts by weight, or 0.07 parts by weight or so. The ratio may be within a range of more than or equal to, or more than any one of the above-described lower limits: within a range of less than or equal to, or less than any one of the above-described upper limits; or within a range of less than or equal to, or less than any one of the above-described upper limits while being more than or equal to, or more than any one of the above-described lower limits. When the content of the cross-linking agent is selected to cross-link the acrylic copolymer at an appropriate level within the content range, it is possible to effectively form the desired pressure-sensitive adhesive.

The pressure-sensitive adhesive layer may comprise, as the cross-linking agent, a so-called radical cross-linking agent which is a cross-linking agent of a different type from the thermal cross-linking agent. Such a cross-linking agent implements a cross-linked structure by radical reaction. Such a radical cross-linking agent may be exemplified by a so-called polyfunctional acrylate, which may include, for example, bifunctional acrylates such as 1,4-butanediol di(meth)acrylate, 1,6-hexanediol di(meth)acrylate, neopentylglycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified di(meth)acrylate, di(meth)acryloxyethyl isocyanurate, allylated cyclohexyl di(meth)acrylate, tricyclodecanedimethanol(meth)acrylate, dimethylol dicyclopentane di(meth)acrylate, ethylene oxide-modified hexahydrophthalic acid di(meth)acrylate, tricyclodecane dimethanol(meth)acrylate, neopentyl glycol-modified trimethylpropane di(meth)acrylate, adamantane di(meth)acrylate or 9,9-bis [4-(2-acryloyloxyethoxy)phenyl]fluorene: trifunctional acrylates such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, trifunctional urethane (meth)acrylate, or tris(meth)acryloxyethyl isocyanurate: tetrafunctional acrylates such as diglycerin tetra(meth)acrylate or pentaerythritol tetra(meth)acrylate: pentafunctional acrylates such as propionic acid-modified dipentaerythritol penta(meth)acrylate; and hexafunctional acrylates such as dipentaerythritol hexa(meth)acrylate, caprolactone-modified dipentaerythritol hexa(meth)acrylate or urethane (meth)acrylate (e.g., a reactant of an isocyanate monomer and trimethylol propane tri(meth)acrylate, etc.), and the like, but is not limited thereto.

The radical cross-linking agent in the pressure-sensitive adhesive layer may also be present in an appropriate ratio depending on the purpose, which may be included, for example, in an amount of 0.01 parts by weight to 10 parts by weight or 0.01 parts by weight to 5 parts by weight relative to 100 parts by weight of the acrylic copolymer.

The radical cross-linking agent does not correspond to an essential component.

In addition to the above components, the pressure-sensitive adhesive may comprise appropriate additional components as needed, which may also comprise, for example, components of a radical initiator, an ultraviolet absorber, a light stabilizer, a plasticizer, and/or a cross-linking catalyst, and the like.

In the present application, a method of forming the pressure-sensitive adhesive is not particularly limited. For example, the pressure-sensitive adhesive may be formed by applying the pressure-sensitive adhesive composition, in which the respective components (the copolymer and cross-linking agent, etc.) to form the pressure-sensitive adhesive are compounded, with an appropriate cross-linking method in consideration of the type of the applied acrylic copolymer and/or cross-linking agent. For example, if the acrylic copolymer and/or cross-linking agent is a type cross-linked by application of heat, a cross-linked product may be formed by applying appropriate heat, and if it is a type cross-linked by irradiation with electromagnetic waves, a cross-linked product may be formed by irradiation with appropriate electromagnetic waves, and other cross-linking methods may also be applied.

Such a pressure-sensitive adhesive may exhibit the above-described elastic modulus and/or peel force characteristics.

The thickness of such a pressure-sensitive adhesive of the present application is not particularly limited, and it may have a thickness of a conventional pressure-sensitive adhesive in consideration of the applied use.

For example, the pressure-sensitive adhesive may have an appropriate level of thickness within the range of approximately 5 μm to 100 μm.

The present application also relates to a pressure-sensitive adhesive film or an optical laminate, which comprises a base film and a pressure-sensitive adhesive layer formed on one or both sides of the base film. In the case of the optical laminate, the base film may be an optical film. The pressure-sensitive adhesive layer may comprise the above-described pressure-sensitive adhesive.

The pressure-sensitive adhesive layer of the present application may be formed on one or both sides of the base film to form a pressure-sensitive adhesive film, or may be formed on one or both sides of the base film, which is an optical film, to form an optical laminate.

In this instance, the type of the applicable base film is not particularly limited. As the base film, a base film which is applicable to the formation of the pressure-sensitive adhesive film may be usually applied.

For example, as the base film, a PET (poly(ethylene terephthalate)) film, a PTFE (poly(tetrafluoroethylene)) film, a PP (polypropylene) film, a PE (polyethylene) film, a polyimide film, a polyamide film, a COP (cyclic olefin polymer) film, a polybutene film, a polybutadiene film, a vinyl chloride copolymer film, a polyurethane film, an ethylene-vinyl acetate film, an ethylene-propylene copolymer film, an ethylene-ethyl acrylate copolymer film, an ethylene-methyl acrylate copolymer film and/or a polyimide film, and the like may be used, without being limited thereto.

The thickness of the base film is not particularly limited, and it may have an appropriate thickness within a range suitable for the purpose.

When the optical film is applied as the base film, the type of the optical film is not particularly limited. In one example, the optical film may be a polarizing film, a polarizing plate, or a retardation film, and the like. Even in this case, the optical film may have a thickness in an appropriate range depending on the purpose.

The pressure-sensitive adhesive film or the optical laminate may further comprise a release film or a protective film for protecting the pressure-sensitive adhesive layer until use, if necessary.

The present application also relates to a flexible device comprising the pressure-sensitive adhesive layer, the pressure-sensitive adhesive film, or the optical laminate, which comprises the pressure-sensitive adhesive. In the device, the application form of the pressure-sensitive adhesive layer, the pressure-sensitive adhesive film, or the optical laminate is not particularly limited, which comprises the pressure-sensitive adhesive. For example, the pressure-sensitive adhesive layer may be used for the application of a so-called OCA (Optically Clear Adhesive) or OCR (Optically Clear Resin) in the device, and thus the application form of the pressure-sensitive adhesive layer, the pressure-sensitive adhesive film, or the optical laminate may be the same as the application form of the conventional OCA or OCR.

In this case, in one example, the flexible device may comprise a display panel and the pressure-sensitive adhesive layer, pressure-sensitive adhesive film, or optical laminate present on one or both sides of the display panel. In this case, the display panel may be configured to be folded or rolled through one or more folding shafts or rolling shafts.

Other elements constituting such a flexible device are not particularly limited, where well-known components of the flexible device may be employed without limitation.

### Advantageous Effects

The present application may provide a pressure-sensitive adhesive, which is applied to a flexible device, thereby effectively responding to repeated deformation and recovery, causing no defects (for example, observation of deformation traces and the like) before and after deformation, having excellent cuttability and workability, and causing no lifting, delamination, and/or bubble generation.

The present application may also provide a pressure-sensitive adhesive layer comprising the pressure-sensitive adhesive, and a pressure-sensitive adhesive film or optical film, and a flexible device such as a foldable device or a rollable device, which comprise the same.

### DESCRIPTION OF DRAWINGS

FIG. 1 is a diagram showing a structure of a specimen applied in a dynamic folding test.

FIG. 2 is a diagram showing a process in which a dynamic folding test is performed.

FIG. 3 is a diagram showing a content which evaluates cuttability of a pressure-sensitive adhesive.

### MODE FOR INVENTION

Hereinafter, the present application will be described in detail below through examples and comparative examples, but the scope of the present application is not limited by the following examples.

### 1. Evaluation of Storage Elastic Modulus

The storage elastic modulus was evaluated using ARES G2 (Advanced Rheometric Expansion System G2) (TA). A specimen was prepared by cutting a pressure-sensitive adhesive layer having a thickness of about 0.8 mm or so into a circle having a diameter of about 8 mm or so. The pressure-sensitive adhesive layer was prepared by overlapping pressure-sensitive adhesive layers having a thickness of about 25 μm or so to have a thickness of about 0.8 mm or so. The storage elastic modulus at the measurement temperature was evaluated for the specimen using a parallel plate fixture having a diameter of about 8 mm. Upon the evaluation, the evaluation conditions were set to a frequency of 1 Hz and a strain of 5%, and the measurement was made while increasing the temperature from −40° C. to 90° C. at a rate of about 10° C./min.

### 2. Peel Force Evaluation

A specimen was prepared by cutting the pressure-sensitive adhesive film to be measured (the structure of the release film/pressure-sensitive adhesive layer/base film) into a rectangle having a width of about 25 mm or so and a length of about 100 mm or so. Subsequently, the release film was peeled off, and the pressure-sensitive adhesive layer was attached to a soda lime glass according to JIS Z 0237 using a roller of 2 kg and left at room temperature for 1 day. Thereafter, the peel force was measured using a TA (Texture Analyzer) instrument (Stable Micro System), while peeling the pressure-sensitive adhesive layer at a peel angle of 180 degrees and a peel rate of 0.3 m/min at room temperature.

### 3. Haze Measurement

Haze was measured after attaching a pressure-sensitive adhesive with a thickness of about 25 μm to soda lime glass with a thickness of 0.5 mm using a 2 kg roller according to the provision of JIS Z 0237 and leaving it at room temperature for 1 day. As a measuring instrument, a COH-400 instrument (Nippon Denshoku) was used, and it was evaluated using a D65 standard light source.

### 4. Evaluation of Weight Average Molecular Weight

A weight average molecular weight (Mw) and a molecular weight distribution were measured using GPC (Gel Permeation Chromatograph), and the measurement conditions are as follows. When measuring the weight average molecular weight, the measurement results were converted using standard polystyrene (manufactured by Agilent system) to prepare a calibration curve. The molecular weight distribution was calculated as a value (Mw/Mn) by obtaining the weight average molecular weight (Mw) and the number average molecular weight (Mn) according to the above method, and then dividing them.

### <GPC Measurement Conditions>

Measuring instrument: Agilent GPC (Agilent 1200 series, U.S.)
Column: connecting two PL Mixed B
Column temperature: 40° C.
Eluent: THF (tetrahydrofuran)
Flow rate: 1.0 μL/min
Concentration: ˜1 mg/mL (100 μl injection)

### 5. Dynamic Folding Test

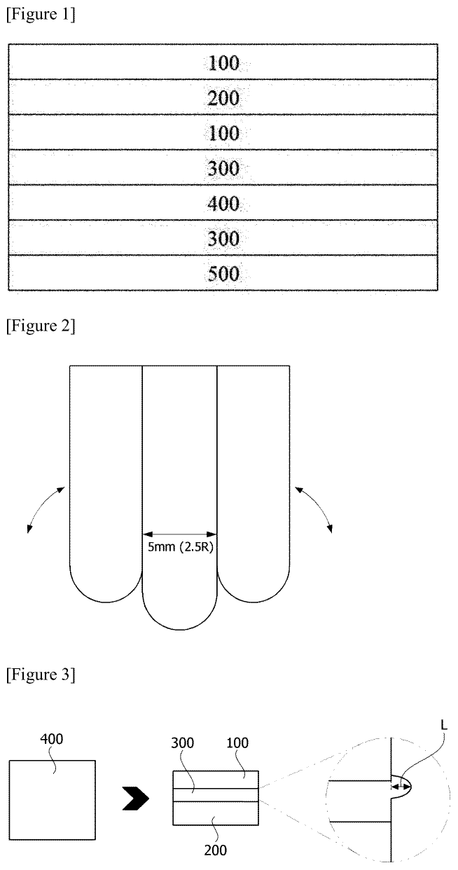

A dynamic folding test was performed by preparing a specimen as shown in FIG. 1. A laminate prepared by sequentially laminating a polyimide film (200) having a thickness of about 50 μm or so in which hard coating layers (100) were formed on both sides, a pressure-sensitive adhesive layer (300), a polarizing plate (400), a pressure-sensitive adhesive layer (300), and a display panel (500) as in the specimen as shown in FIG. 1 was cut into a rectangular shape having a horizontal length of about 7.8 cm and a vertical length of about 17 cm or so to prepare the specimen. Subsequently, as shown in FIG. 2, the folding that the specimen was sandwiched between parallel plates with an interval of 5 mm and folded was repeated 200,000 times at −20° C., and the sample was collected, and then defects such as bubble generation, occurrence of lifting/delamination, occurrence of cracks in the coating layer were visually observed. A case in which even one of the above defects occurred was evaluated as NG, and a case in which all the above defects did not occur was evaluated as PASS.

### 6. Cuttability Test

As shown in FIG. 3, cuttability was evaluated using a specimen (400) prepared by cutting a laminate with a pressure-sensitive adhesive layer (300) present between two release films (light liner, heavy liner) (100, 200) to have horizontal and vertical lengths of 10 cm, respectively. As shown in FIG. 3, the stickiness loss length (L) occurring upon cutting was measured, and if the length was 100 μm or more, it was evaluated as NG, and if it was less than 100 μm, it was evaluated as PASS.

### 7. Evaluation of Melting Point and Glass Transition Temperature

A melting point was measured according to a measurement method using a conventional DSC (Differential Scanning calorimeter) equipment. As the equipment, DSC2500 equipment (TA) was used. About 10 mg of the sample (copolymer) was sealed in a dedicated pan, and the melting point and the glass transition temperature were measured by setting the warming condition to 10° C./min and the cooling condition to −10° C./min, and identifying endothermic and exothermic heat quantities depending on the temperature in an N2 atmosphere. The measurement temperature range was −120° C. to 200° C. Regarding the conditions, first, it was cooled from room temperature (about 30° C.) to −120° C. at a rate of about −10° C./min, and heated again to 200° C. at a temperature increase rate of 10° C./min (primary heating). Thereafter, it was cooled to −120° C. at a rate of about −10° C./min again, and heated again to 200° C. at a temperature increase rate of 10° C./min (secondary heating). The melting point was evaluated upon the second heating.

### Preparation Example 1. Preparation of Copolymer (A)

A monomer mixture was introduced into a 1 L reactor refluxed with nitrogen gas and equipped with a cooling device to facilitate temperature control. As the monomer mixture, a mixture in which n-butyl acrylate (BA), lauryl acrylate (LA), and 4-hydroxybutyl acrylate (HBA) were mixed in a weight ratio of 6:3:1 (BA:LA:HBA) was applied. The monomer mixture was introduced and an appropriate amount of ethyl acetate was added, oxygen was removed by purging with nitrogen gas for 1 hour, and the temperature of the reactor was maintained at about 62° C. or so. The reaction was initiated by making the mixture uniform, adding a reaction initiator (AIBN: azobisisobutyronitrile) at about 400 ppm or so, and adding also n-dodecyl mercaptan at about 400 ppm or so. The mixture was reacted for about 6 hours to 7 hours or so to prepare a polymer (copolymer (A)). The weight average molecular weight of the copolymer (polymerization product) (A) was about 2,000,000 or so, and the molecular weight distribution was about 4.5 or so. Also, the melting point of the copolymer (polymerization product) (A) was about −43° C. or so.

### Preparation Example 2. Preparation of Copolymer (B)

A copolymer (polymerization product) (B) was prepared in the same manner as Preparation Example 1, except that as a monomer mixture, a mixture in which ethylhexyl acrylate (EHA), lauryl acrylate (LA), and 4-hydroxybutyl acrylate (HBA) were mixed in a weight ratio of 4:4:2 (EHA:LA:HBA) was used. The weight average molecular weight of the copolymer (polymerization product) (B) was about 2,000,000 or so, and the molecular weight distribution was about 3.5 or so. Also, the melting point of the copolymer (polymerization product) (B) was about −42° C. or so.

### Preparation Example 3. Preparation of Copolymer (C)

A copolymer (polymerization product) (C) was prepared in the same manner as Preparation Example 1, except that as a monomer mixture, a mixture in which as a monomer mixture, a mixture in which n-butyl acrylate (BA), lauryl acrylate (LA), and 4-hydroxybutyl acrylate (HBA) were mixed in a weight ratio of 58:40:2 (BA:LA:HBA) was used. The weight average molecular weight of the copolymer (polymerization product) (C) was about 2,000,000 or so, and the molecular weight distribution was about 3.5 or so. Also, the melting point of the copolymer (C) was about −42° C. or so.

### Example 1

A pressure-sensitive adhesive composition was prepared by formulating about 0.07 parts by weight of an isocyanate cross-linker (TKA-100, Needfill Co.), about 10 parts by weight of TEG-EH (triethylene glycol bis(2-ethylhexanoate)), and a catalytic amount of catalyst relative to 100 parts by weight of the copolymer (polymerization product) (A) of Preparation Example 1. As the catalyst, a catalyst promoting a urethane reaction of a hydroxy group and an isocyanate group was typically used. The pressure-sensitive adhesive composition was diluted to an appropriate viscosity with a solvent (ethyl acetate) and mixed with a mechanical stirrer for 15 minutes or more. It was maintained at room temperature to remove air bubbles, applied on a release film (release PET (poly(ethylene terephthalate))) with a comma coater, and then kept at 140° C. for about 3 minutes or so to form a pressure-sensitive adhesive layer with a thickness of about 25 μm or so.

### Example 2

A pressure-sensitive adhesive layer with a thickness of about 25 μm or so was formed in the same manner as in Example 1, except that DEHA (diethylhexyl adipate) was used instead of TEG-EH (triethylene glycol bis(2-ethylhexanoate)).

### Comparative Example 1

A pressure-sensitive adhesive layer with a thickness of about 25 μm or so was formed in the same manner as in Example 1, except that TEG-EH (triethylene glycol bis(2-ethylhexanoate)) was not applied.

### Comparative Example 2

A pressure-sensitive adhesive layer with a thickness of about 25 μm or so was formed in the same manner as in Example 1, except that IPMS (isopropyl myristate) was applied instead of TEG-EH (triethylene glycol bis(2-ethylhexanoate)).

### Comparative Example 3

A pressure-sensitive adhesive layer with a thickness of about 25 μm or so was formed in the same manner as in Example 1, except that TEC (triethyl citrate) was applied instead of TEG-EH (triethylene glycol bis(2-ethylhexanoate)).

### Comparative Example 4

A pressure-sensitive adhesive layer with a thickness of about 25 μm or so was formed in the same manner as in Example 1, except that ATBC (acetyl tributyl citrate) was used instead of TEG-EH (triethylene glycol bis(2-ethylhexanoate)).

### Comparative Example 5

A pressure-sensitive adhesive layer with a thickness of about 25 μm or so was formed in the same manner as in Example 1, except that the copolymer (B) of Preparation Example 2 was used instead of the copolymer (A) of Preparation Example 1, and TEG-EH (triethylene glycol bis(2-ethylhexanoate)) was not applied.

### Comparative Example 6

A pressure-sensitive adhesive layer with a thickness of about 25 μm or so was formed in the same manner as in Example 1, except that the copolymer (C) of Preparation Example 3 was used instead of the copolymer (A) of Preparation Example 1, and TEG-EH (triethylene glycol bis(2-ethylhexanoate)) was not applied.

The evaluation results for the storage elastic modulus, haze, peel force, dynamic folding test, and cuttability evaluated for the pressure-sensitive adhesive layers of Examples and Comparative Examples are as summarized in Table 1 below.

In Table 1 below, G′ (−20) is the storage elastic modulus at −20° C., G′ (25) is the storage elastic modulus at 25° C., ΔG is the change amount of elastic modulus identified by Equation 1 above, and DF is the result of the folding test.

In Table 1, the unit of storage elastic modulus is Pa, and the unit of peel force is gf/inch.

TABLE 1

| | Example | | Comparative Example | | | | | |
|---|---|---|---|---|---|---|---|---|
| | 1 | 2 | 1 | 2 | 3 | 4 | 5 | 6 |
| Peel force | 2425 | 2300 | 2608 | 2406 | 2454 | 2570 | 1650 | 751 |
| Haze (%) | 0.17 | 0.39 | 0.54 | 0.59 | 0.42 | 0.54 | 0.45 | 0.4 |
| G′(−20) | 96000 | 84000 | 160000 | 150000 | 160000 | 110000 | 800000 | 88000 |
| G′(25) | 38000 | 36000 | 51000 | 50000 | 51000 | 41000 | 23000 | 41000 |
| ΔG | 1289 | 1067 | 2422 | 2222 | 2422 | 1533 | 17267 | 1044 |
| DF | PASS | PASS | NG | NG | NG | NG | PASS | NG |
| Cuttability | PASS | PASS | PASS | PASS | PASS | NG | NG | PASS |

1. A pressure-sensitive adhesive comprising a cross-linked acrylic copolymer, and
having a storage elastic modulus at −20° C. of 100,000 Pa or less,
a peel force of 1,700 gf/inch or more to glass, and
haze of 0.5% or less.

2. A pressure-sensitive adhesive comprising a cross-linked acrylic copolymer, and
having an elastic modulus change rate of 2500 or less according to Equation 1 below, and
haze of 0.5% or less:
$$Elastic modulus change rate = ( M 20 - M 25 ) / 45 \qquad [ Equation l ]$$
wherein, M20 is a storage elastic modulus of the pressure-sensitive adhesive at −20° C., and M25 is a storage elastic modulus of the pressure-sensitive adhesive at 25° C.

3. A pressure-sensitive adhesive comprising a cross-linked acrylic copolymer and a compound of Formula 1 below: 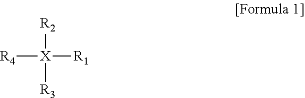
wherein, X is carbon or nitrogen, R₁ to R₃ are each independently hydrogen, an alkyl group, or a hydroxy group, and R₄ is a substituent of Formula 2 below, but when X is nitrogen, R₄ is not present, and at least one of R₁ to R₃ is a hydroxy group: 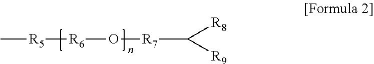
wherein, R₅ is a single bond, an oxygen atom, -L₁-C(═O)-L₂-, -L₁-C(═O)—O-L₂-, or -L₁-O—C(═O)-L₂-, where L₁ and L₂ are each independently a single bond, an alkylene group, or an alkylidene group, R₆ is an alkylidene group or an alkylene group, R₇ is a single bond, —O—C(═O)—, —C(═O)—, or —C(═O)—O—, R₈ and R₉ are each independently hydrogen or an alkyl group, and n is a number in a range of 0 to 10.

4. The pressure-sensitive adhesive according to claim 2, wherein the storage elastic modulus at −20° C. is 100,000 Pa or less.

5. The pressure-sensitive adhesive according to claim 2, wherein the peel force to glass is 1,800 gf/inch or more.

6. The pressure-sensitive adhesive according to claim 1, wherein the storage elastic modulus at 25° C. is 10,000 Pa or more.

7. The pressure-sensitive adhesive according to claim 1, wherein the acrylic copolymer has a weight average molecular weight of 1,000,000 or more.

8. The pressure-sensitive adhesive according to claim 1, wherein the acrylic copolymer comprises an alkyl (meth)acrylate unit, a unit of Formula 3 below, and a polar functional group-containing unit: 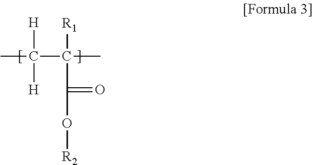
wherein, R₁ represents hydrogen or an alkyl group, and R₂ represents an alkyl group with 11 to 13 carbon atoms.

9. The pressure-sensitive adhesive according to claim 8, wherein the alkyl (meth)acrylate unit has a linear or branched alkyl group with 1 to 10 carbon atoms.

10. The pressure-sensitive adhesive according to claim 8, wherein the polar functional group-containing unit is a unit derived from a hydroxy group-containing monomer.

11. The pressure-sensitive adhesive according to claim 8, wherein the acrylic copolymer contains the alkyl (meth)acrylate unit in a ratio of 10 wt % to 80 wt %.

12. The pressure-sensitive adhesive according to claim 8, wherein the acrylic copolymer contains 10 to 300 parts by weight of the unit of Formula 3 relative to 100 parts by weight of the alkyl (meth)acrylate unit.

13. The pressure-sensitive adhesive according to claim 8, wherein the acrylic copolymer contains 1 to 100 parts by weight of the polar functional group-containing unit relative to 100 parts by weight of the alkyl (meth)acrylate unit.

14. A pressure-sensitive adhesive film comprising a base film; and
the pressure-sensitive adhesive of claim 1 formed on one or both sides of the base film.

15. An optical laminate comprising an optical film; and the pressure-sensitive adhesive of claim 1 formed on one or both sides of the optical film.

16. A flexible device comprising a display panel configured to be foldable or rollable through one or more folding shafts or rolling shafts; and
the pressure-sensitive adhesive of claim 1 present on one or both sides of the display panel.
